(19) United States
(12) Patent Application Publication
(10) Pub. No.: US 2025/0185720 A1
(43) Pub. Date: Jun. 12, 2025

(54) AEROSOL PROVISION DEVICE LOCATION SYSTEM AND METHOD

(71) Applicant: NICOVENTURES TRADING LIMITED, London, ENG (GB)

(72) Inventors: Sally BELL, London (GB); Joseph Peter SUTTON, London (GB)

(21) Appl. No.: 18/845,423

(22) PCT Filed: Mar. 15, 2023
(86) PCT No.: PCT/GB2023/050606

§ 371 Date: Sep. 9, 2024

(30) Foreign Application Priority Data
Mar. 16, 2022 (GB) 2203620.6

(51) Int. Cl. A24F 40/51; A24F 40/65

(52) U.S. Cl. CPC A24F 40/51; A24F 40/65

(57) ABSTRACT

An aerosol provision system comprises one or more sensors and control circuitry. The control circuitry is configured to receive information from the one or more sensors, and determine a location of the aerosol provision system based on the received information.

### TECHNICAL FIELD

The present invention relates to an aerosol provision device, aerosol provision system and method.

### BACKGROUND

Electronic aerosol provision systems such as electronic cigarettes (e-cigarettes) generally contain an aerosol-generating material, such as a reservoir of a source liquid containing a formulation, typically including nicotine, or a solid material such as a tobacco-based product, from which an aerosol is generated for inhalation by a user, for example through heat vaporisation. Thus, an aerosol provision system will typically comprise an aerosol generator, e.g. a heating element, arranged to aerosolise a portion of aerosol-generating material to generate an aerosol in an aerosol generation region of an air channel through the aerosol provision system. As a user inhales on the device and electrical power is supplied to the aerosol generator, air is drawn into the device through one or more inlet holes and along the air channel to the aerosol generation region, where the air mixes with the vaporised aerosol generator and forms a condensation aerosol. The air drawn through the aerosol generation region continues along the air channel to a mouthpiece, carrying some of the aerosol with it, and out through the mouthpiece for inhalation by the user.

It is common for aerosol provision systems to comprise a modular assembly, often having two main functional parts, namely an aerosol provision device and an article. Typically, the article will comprise the article aerosol-generating material and the aerosol generator (heating element), while the aerosol provision device part will comprise longer-life items, such as a rechargeable battery, device control circuitry and user interface features. The aerosol provision device may also be referred to as a reusable part or battery section and the article may also be referred to as a consumable, disposable/replaceable part, cartridge or cartomiser.

The aerosol provision device and article are mechanically coupled together at an interface for use, for example using a screw thread, bayonet, latched or friction fit fixing. When the aerosol-generating material in an article has been exhausted, or the user wishes to switch to a different article having a different aerosol-generating material, the article may be removed from the aerosol provision device and a replacement article may be attached to the device in its place.

As the aerosol provision system is a handheld and portable device, the user of the aerosol provision system may drop, misplace or otherwise lose the aerosol provision system. If the aerosol provision system does not have a means of determining its own location, it can be very difficult to find the aerosol provision system when it has been lost in the absence of additional information.

Various approaches are described herein which seek to help address or mitigate some of the issues discussed above.

### SUMMARY

The disclosure is defined in the appended claims.

In accordance with some embodiments described herein, there is provided an aerosol provision system comprising one or more sensors and control circuitry configured to receive information from the one or more sensors, and determine a location of the aerosol provision system based on the received information.

The one or more sensors can comprise an optical sensor configured to measure an amount of light proximate to the aerosol provision system. The one or more sensors can comprise an accelerometer configured to measure an orientation of the aerosol provision system. The one or more sensors can comprise a current sensor configured to measure an amount of current received from an external power supply. The one or more sensors can comprise a temperature sensor configured to measure a temperature of the aerosol provision system.

The control circuitry can be configured to receive the information from the one or more sensors in response to receiving a request from an external device.

Determining the location of the aerosol provision system can be further based on location information stored in a database, wherein the location information comprises correlations between information previously received from the one or more sensors and previously determined locations of the aerosol provision system. The control circuitry can be further configured to update the location information based on the received information and the location of the aerosol provision system.

The control circuitry can be further configured to send an indication of the location of the aerosol provision system to an external device.

In accordance with some embodiments described herein, there is provided an aerosol provision device for an aerosol provision system comprising control circuitry configured to receive information from one or more sensors of the aerosol provision system, and determine a location of the aerosol provision system based on the received information.

In accordance with some embodiments described herein, there is provided a method for operating an aerosol provision system comprising receiving information from one or more sensors of the aerosol provision system and determining a location of the aerosol provision system based on the received information.

There is also provided a non-transitory computer readable storage medium comprising instructions which, when executed by a processor, performs the above method.

These aspects and other aspects will be apparent from the following detailed description. In this regard, particular sections of the description are not to be read in isolation from other sections.

### BRIEF DESCRIPTION OF DRAWINGS

Embodiments of the invention will now be described, by way of example only, with reference to accompanying drawings, in which:

FIG. 1 is a schematic diagram of an aerosol provision system;

FIG. 2 is a schematic diagram of a system comprising an aerosol provision system;

FIG. 3 is a flow diagram of a method for operating an aerosol provision system.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of articles and systems discussed herein which are not described in detail may be implemented in accordance with any conventional techniques for implementing such aspects and features.

The present disclosure relates to aerosol provision systems, which may also be referred to as vapour provision systems, such as e-cigarettes. Throughout the following description the term “e-cigarette” or “electronic cigarette” may sometimes be used, but it will be appreciated this term may be used interchangeably with aerosol provision system and electronic aerosol provision system.

As noted above, aerosol provision systems (e-cigarettes) often comprise a modular assembly including both a reusable part (aerosol provision device) and a replaceable (disposable) or refillable cartridge part, referred to as an article. Systems conforming to this type of two-part modular configuration may generally be referred to as two-part systems or devices. It is also common for electronic cigarettes to have a generally elongate shape. For the sake of providing a concrete example, certain embodiments of the disclosure described herein comprise this kind of generally elongate two-part system employing refillable cartridges. However, it will be appreciated the underlying principles described herein may equally be adopted for other electronic cigarette configurations, for example modular systems comprising more than two parts, as devices conforming to other overall shapes, for up example based on so-called box-mod high performance devices that typically have a more boxy shape, or even systems comprising one part where the aerosol provision device and article are integrally formed with one another.

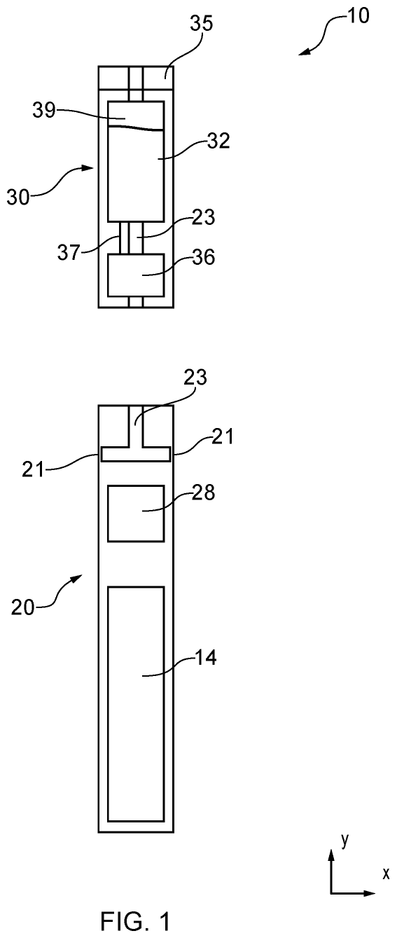

FIG. 1 is a highly schematic diagram (not to scale) of an example aerosol provision system 10, such as an e-cigarette, to which embodiments are applicable. The aerosol provision system 10 has a generally cylindrical shape, extending along a longitudinal or y axis as indicated by the axes (although aspects of the invention are applicable to e-cigarettes configured in other shapes and arrangements), and comprises two main components, namely an aerosol provision device 20 and an article 30.

The article 30 comprises or consists of aerosol-generating material 32, part or all of which is intended to be consumed during use by a user. An article 30 may comprise one or more other components, such as an aerosol-generating material storage area 39, an aerosol-generating material transfer component 37, an aerosol generation area, a housing, a wrapper, a mouthpiece 35, a filter and/or an aerosol-modifying agent.

An article 30 may also comprise an aerosol generator 36, such as a heating element, that emits heat to cause the aerosol-generating material 32 to generate aerosol in use. The aerosol generator 36 may, for example, comprise combustible material, a material heatable by electrical conduction, or a susceptor. It should be noted that it is possible for the aerosol generator 36 to be part of the aerosol provision device 20 and the article 30 then may comprise the aerosol-generating material storage area 39 for the aerosol-generating material 32 such that, when the article 30 is coupled with the aerosol provision device 20, the aerosol-generating material 32 can be transferred to the aerosol generator 36 in the aerosol provision device 20. It should be appreciated that the aerosol generator 36 may encompass an aerosol generator other than a heater. More generally, an aerosol generator is an apparatus configured to cause aerosol to be generated from the aerosol-generating material. In some other embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

Aerosol-generating material is a material that is capable of generating aerosol, for example when heated, irradiated or energized in any other way. The aerosol-generating material 32 may, for example, be in the form of a solid, liquid or gel which may or may not contain an active substance and/or flavourants. In some embodiments, the aerosol-generating material 32 may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material 32 may for example comprise from about 50 wt %, 60 wt % or 70 wt % of amorphous solid, to about 90 wt %, 95 wt % or 100 wt % of amorphous solid.

The aerosol-generating material comprises one or more ingredients, such as one or more active substances and/or flavourants, one or more aerosol-former materials, and optionally one or more other functional materials such as pH regulators, colouring agents, preservatives, binders, fillers, stabilizers, and/or antioxidants.

The active substance as used herein may be a physiologically active material, which is a material intended to achieve or enhance a physiological response. The active substance may for example be selected from nutraceuticals, nootropics, and psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

The aerosol provision device 20 includes a power source 14, such as a battery, configured to supply electrical power to the aerosol generator 36. The power source 14 in this example is rechargeable and may be of a conventional type, for example of the kind normally used in electronic cigarettes and other applications requiring provision of relatively high currents over relatively short periods. The power source 14 may be recharged through the charging port (not illustrated), which may, for example, comprise a USB connector.

The aerosol provision device 20 includes device control circuitry 28 configured to control the operation of the aerosol provision system 10 and provide conventional operating functions in line with the established techniques for controlling aerosol provision systems such as electronic cigarettes. The device control circuitry (processor circuitry) 28 may be considered to logically comprise various sub-units/circuitry elements associated with different aspects of the electronic cigarette's operation. For example, depending on the functionality provided in different implementations, the device control circuitry 28 may comprise power source control circuitry for controlling the supply of electrical power from the power source 14 to the aerosol generator 36, user programming circuitry for establishing configuration settings (e.g. user-defined power settings) in response to user input, as well as other functional units/circuitry associated functionality in accordance with the principles described herein and conventional operating aspects of electronic cigarettes. It will be appreciated the functionality of the device control circuitry 28 can be provided in various different ways, for example using one or more suitably programmed programmable computer(s) and/or one or more suitably configured application-specific integrated circuit(s)/circuitry/chip(s)/chipset(s) configured to provide the desired functionality.

The aerosol provision device 20 has an interface configured to receive the article 30, thereby facilitating the coupling between the aerosol provision device 20 and the article 30. The interface is located on a surface of the aerosol provision device 20.

The housing of the article 30 has a surface configured to be received by the interface on the aerosol provision device 20 in order to facilitate coupling between the article 30 and the aerosol provision device 20. The surface of the article may be configured to be a size and/or shape that mirrors the size and/or shape of the interface in order to facilitate coupling between the aerosol provision device 20 and the article 30. For example, the interface may comprise a cavity, chamber or other space on the surface of the aerosol provision device 20. The surface of the article 30 can then be configured to be a size and shape that mirrors the size and shape of the cavity in order for the surface of the article 30 to be inserted into the cavity.

Although not illustrated, the interface of the aerosol provision device 20 and the surface of the article 30 may have complementary features to reversibly attach and mate the article 30 to the aerosol provision device 20, such as a screw thread, bayonet fitting, latched or friction fit fixing or other fastening means.

The interface also comprises one or more connectors, such as contact electrodes, connected via electrical wiring to the control circuitry 28 and the power source 14. The article 30 also comprises one or more connectors, such as contact electrodes, connected via electrical wiring to the aerosol generator 36. In use, the article 30 is received by the interface of the aerosol provision device 20, thereby coupling the aerosol provision device 20 and the article 30. This results in the connectors on the article 30 mating with the connectors on the aerosol provision device 20, thereby allowing electrical power and electrical current to be supplied from the power source 14 of the aerosol provision device 20 to the aerosol generator 36 of the article 30.

The housing of the article 30 has a surface configured to engage with an interface on the aerosol provision device 20 in order to facilitate coupling between the article 30 and the aerosol provision device 20. In other words, the aerosol provision device 20 is configured to receive the article 30, via the interface, and the surface of the article is proximate to the interface on the aerosol provision device 20 when the article 20 is received by the interface.

The aerosol provision system 10 includes one or more air inlets 21, located on one or more of the aerosol provision device 20 and the article 30. In use, as a user inhales on the mouthpiece 35, air is drawn into the aerosol provision system 10 through the air inlets 21 and along an air channel 23 to the aerosol generator 36, where the air mixes with the vaporised aerosol-generating material 32 and forms a condensation aerosol. The air drawn through the aerosol generator 36 continues along the air channel 23 to a mouthpiece 35, carrying some of the aerosol with it, and out through the mouthpiece 35 for inhalation by the user.

By way of a concrete example, the article 30 comprises a housing (formed, e.g., from a plastics material), an aerosol-generating material storage area 39 formed within the housing for containing the aerosol-generating material 32 (which in this example may be a liquid which may or may not contain nicotine), an aerosol-generating material transfer component 37 (which in this example is a wick formed of e.g., glass or cotton fibres, or a ceramic material configured to transport the liquid from the reservoir using capillary action), an aerosol-generating area containing the aerosol generator 36, and a mouthpiece 35. Although not shown, a filter and/or aerosol modifying agent (such as a flavour imparting material) may be located in, or in proximity to, the mouthpiece 35. The aerosol generator 36 of this example comprises a heater element formed from an electrically resistive material (such as NiCr8020) spirally wrapped around the aerosol-generating material transfer component 37, and located in an air channel 23. The area around the heating element and wick combination is the aerosol-generating area of the article 30.

Although not illustrated in FIG. 1, the aerosol provision system 10 also comprises one or more sensors. The one or more sensors can be located on the article 30, on the aerosol provision device 20, or a combination thereof. The control circuitry 28 is configured to receive information from the one or more sensors and determine a location of the aerosol provision system 10 based on received information from the one or more sensors.

One of the sensors can comprise an optical sensor configured to measure the amount of light proximate to the aerosol provision system 10. When the aerosol provision system 10 is located in direct sunlight, the amount of light proximate to the aerosol provision system 10 and detected by the optical sensor will be high, as opposed to when the aerosol provision system 10 is located in a dark room, cupboard, drawer or other enclosed space.

One of the sensors can comprise an accelerometer configured to measure an orientation of the aerosol provision system 10, for example a 6 or 9 axis accelerometer, a MEMS accelerometer, or an IMU. The orientation of the aerosol provision system 10 measured by the accelerometer can indicate whether the aerosol provision system 10 is located on a horizontal flat surface, or whether the aerosol provision system 10 is in a different orientation such as with the article 30 pointing substantially downwards. The accelerometer can also be configured to measure the motion of the aerosol provision system 10, and therefore detect whether the aerosol provision system 10 is stationary, moving at a constant velocity, or undergoing an acceleration or deceleration.

One of the sensors can comprise a current sensor configured to measure an amount of current received from an external power supply. When the power source or battery 14 of the aerosol provision system 10 needs to be recharged, the aerosol provision system 10 can be connected to an external power supply in order to recharge the power source or battery 14. The current sensor can be located between the power source 14 and charging port of the aerosol provision system 10 in order to measure current flow between the external power supply and the power source 14 (i.e. to measure or otherwise detect when the aerosol provision system 10 is connected to an external power supply). As it will be appreciated, electrical devices are typically recharged from an electrical socket or power pack, and users typically recharge their devices at the same location(s), such as a USB or other port of a desk computer, or an electrical socket in a living room or bedroom. The current sensor can therefore detect when the power source 14 of the aerosol provision system 10 is being recharged or when the aerosol provision system 10 is connected to an external power supply, which can be indicative of the location of the aerosol provision system 10.

One of the sensors can comprise a temperature sensor configured to measure temperature associated with the aerosol provision system 10. For example, a temperature sensor may be located on or near external surface of the aerosol provision system 10 to measure an ambient temperature around the aerosol provision system 10. Additionally, or alternatively, a temperature sensor may be located on or proximate to the aerosol generator 36 in order to detect a temperature of the aerosol generator 36. The ambient temperature around the aerosol provision system 10 can be indicative as to whether the aerosol provision system 10 is located inside a building or outside, since the temperature in a building is typically regulated to comfortable temperature for its occupants (for example between 18° C. and 28° C.) whilst the outside air temperature varies based on atmospheric conditions.

As set out above, the control circuitry 28 is configured to determine a location of the aerosol provision system 10 based on the received information from the one or more sensors. In other words, the control circuitry 28 is configured to use the information received from the one or more sensors to determine or otherwise predict where the aerosol provision system 10 is located in the absence of a dedicated location system such as GPS. As is will be appreciated, not all aerosol provision systems 10 have a dedicated location system, such as GPS, that it can use to determine its own location. The present disclosure relates to such aerosol provision systems 10 which do not have a GPS receiver or other conventional means to determine its own location. It will therefore be appreciated that the one or more sensors as defined above do not comprise a GPS receiver, cellular receiver or other form of location or communications means. The one or more sensors described herein are configured to measure or monitor a state or property of the aerosol provision system 10.

As set out above, the amount of light proximate to the aerosol provision system 10, the orientation and/or motion of aerosol provision system 10, the amount of current received from the external power supply, and the ambient temperature and/or temperature proximate to the aerosol generator 36 can provide an indication as to the location of the aerosol provision system 10. Information received from each of the sensors can be combined to determine location of the aerosol provision system 10. For example, if the information received from the optical sensor indicates a high amount of ambient light, information received from the current sensor indicates the aerosol provision system 10 is not currently attached to an external power supply, and the information received from the temperature sensor indicates an ambient temperature of 5° C., the control circuitry 28 can determine that the aerosol provision system 10 is located outside. Equally, if the information received from the accelerometer indicates that the aerosol provision system 10 is stationary and located on a horizontal flat surface, and the information received from the current sensor indicates the aerosol provision system 10 is connected to an external power supply, the control circuitry 28 can determine that the aerosol provision system 10 is located on a table or other surface proximate to a charging means, charging station or electrical socket.

The control circuitry 28 can also be configured to determine additional information in response to receiving the information from the one or more sensors. The additional information may comprise the time, day of the week, date, last known location of the aerosol provision system 10, forecast weather and/or temperature or any other information that may be relevant for determining the location of the aerosol provision system 10. The time, day of a week, and date can be determined using a clock of the control circuit 28, the last known location of the aerosol provision system 10 can be determined by maintaining a database of known locations of the aerosol provision system 10, or by sending a request to an external device, such as a mobile device, handheld computing device, or other electronic device associated with the user and in communication with the aerosol provision system 10, and the forecast weather and/or temperature can be determined by sending a request to the external device or by communicating with a remote server, for example via a communications interface of the control circuitry 28 using Wi-Fi.

The control circuitry 28 can also be configured to determine the location of the aerosol provision system 10 based on location information stored in a database, for example in memory of the control circuitry 28. The location information comprises correlations between information previously received from one more sensors and previously determined locations the aerosol provision system 10. The location information can also comprise any additional information determined by the control circuitry 28 at the time the previous location was determined, such as the time, day of the week, date, last known location of the aerosol provision system 10, forecast weather and/or temperature.

For example, it may be determined previously that the user of the aerosol provision system 10 charges the aerosol provision system 10 overnight in the same location (i.e. on a bedside table between the hours of 22:00 and 07:00). During this time, the current sensor measures the amount of current received from the external power supply, the accelerometer measures or detects the aerosol provision system 10 to be orientated horizontally, the temperature sensor measures an ambient temperature corresponding to room temperature (for example 18 to 24° C.) and the optical sensor measures zero or a small amount of light as the room the aerosol provision system 10 is in a substantially dark. This correlation between the information received from each sensor and the time of day allows the control circuitry 28 to determine that the aerosol provision system 10 is located at its usual overnight charging location. At a later time, for example during the day, control circuitry 28 may determine that the aerosol provision system 10 is located at its overnight charging location based on new information received from the one or more sensors. For example, the information received from the accelerometer and current sensor may still indicate, respectively, that the aerosol provision system 10 is orientated substantially flat and current is being received from the external power supply, whilst the information received from the optical sensor may indicate that a large amount of light is proximate to the aerosol provision system 10. In this case, the control section 28 can determine that the large amount of light is due to the time of day, whilst the information received from the accelerometer and the current sensor is still indicative of the fact the aerosol provision system 10 is located at its overnight charging location. The control circuitry 28 is therefore able to determine that the aerosol provision system 10 is located at its overnight charging location based on correlations between the information previously received from the one or more sensors and previously determined locations of the aerosol provision system, where the information received from the one more sensors may completely or partially match information previously received from one more sensors.

In another illustrative example, it may be determined that the user of the aerosol provision system 10 puts the aerosol provision system 10 in a bag or case at the same or similar time of day on weekdays (i.e. between 08:00 and 08:30) in order to transport the aerosol provision system 10, for example to a place of work. During this time, the current sensor measures no current been received from the external power supply, the accelerometer measures or detects the aerosol provision system 10 to be orientated in a particular orientation, for example the article 30 facing substantially upwards, whilst also detecting motion of the aerosol provision system 10, the temperature sensor measures an ambient temperature and the optical sensor measures zero or a small amount of light as the aerosol provision system 10 is in an enclosed space. At a later time, for example in the evening or at night, the control circuitry 28 may determine that the aerosol provision system 10 is still located in the bag or case based on new information received from the one more sensors. For example, the information received from the accelerometer and current sensor may still indicate, respectively, that the aerosol provision system 10 is in the particular orientation and no current is being received from the external power supply. The optical sensor may still measure zero or a small amount of light, whilst the accelerometer may measure no motion. In this case, the control circuitry 28 can determine that the aerosol provision system 10 is likely to have been left in the bag or case, and therefore that the aerosol provision system 10 is still located in the bag or case.

These are two illustrative examples of how information received from the one more sensors can be used to determine the location of aerosol provision system 10, and in particular how a database of location information can be used to compare the information received from the one or more sensors with all previously received information from the one or more sensors and previously determined locations. It will be appreciated that similar correlations between information received from the one or more sensors and the determined location can be used to determine the location of the aerosol provision system 10.

In response to receiving information from the one more sensors, the control circuitry is configured to determine the location of the aerosol system 10. The control circuitry 28 can then update the location information stored in the database based on the information received from the one or more sensors and the determined location of the aerosol provision system. In this way, the database is updated each time the location is determined by the control circuitry 28.

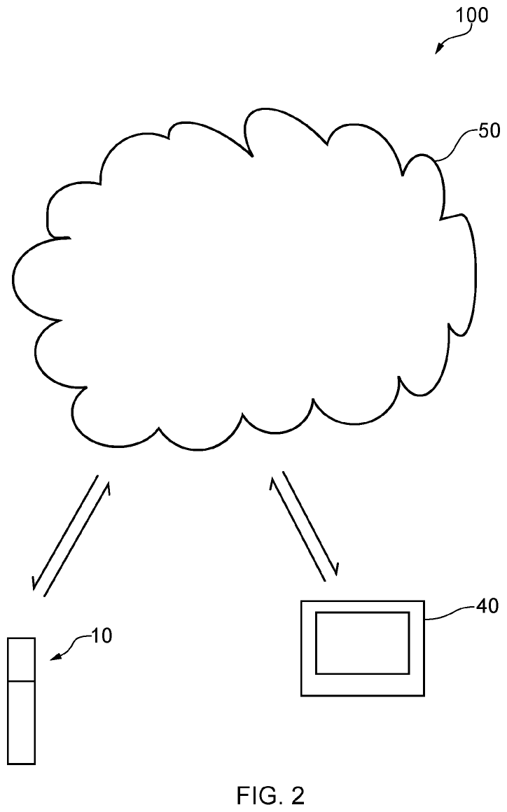

FIG. 2 is a schematic diagram of a system 100 comprising an aerosol provision system 10, where the same reference signs have been used to denote same components in FIGS. 1 and 2. System 100 comprises an aerosol provision system 10, an external computing device 40 and a network 50. The external device 40 can be a device associated with the aerosol provision system 10, for example a mobile device, handheld computing device, or other electronic device. The external device 40 is configured to communicate with the aerosol provision system 10 via the network 50. For example, the external device 40 can comprise a communications interface configured to communicate with the control circuitry 28 of the aerosol provision device 20 via the network. The external device 40 and the aerosol provision system 10 can communicate using a suitable wireless communications protocol such as Wi-Fi, Bluetooth, RFID, NFC.

The external device 40 may be associated with a user of the aerosol provision system 10 such that the aerosol provision system 10 and the external device 40 may be associated with one another, for example via a user profile of the user of aerosol provision system 10.

The control circuitry 28 can be configured to receive the information from the one or more sensors in response to receiving a request from the external device 40. For example, when the user of the aerosol provision system 10 loses or otherwise misplaces the aerosol provision system 10, the user can provide an input on the external device 40 to indicate that the aerosol provision system 10 is lost. The external device 40 is then configured to send a request to the control circuitry 28 of the aerosol provision system 10, for example via the network 50. In response to receiving the request, the control circuitry 28 is configured to receive the information from the one or more sensors and determine the location of the aerosol provision system 10. For example, in response to receiving the request from the external device 40, the control circuitry 28 can request the information from each of the one more sensors, or the control circuitry 28 can otherwise communicate with each of the one or more sensors in order to receive the information.

In response to determining the location of the aerosol provision system 10, the control circuitry 28 can also be configured to send an indication of the location of the aerosol provision system 10 to the external device 40, for example via the network 50. The external device 40 may then be configured to provide the indication of the location of the aerosol provision system 10 to the user, for example by displaying a message on a display screen of the external device 40. In this way, the user of the aerosol provision system 10 can be provided an indication of the location of the aerosol provision system 10, determined by the control circuitry 28, in the event that the user loses, drops or otherwise misplaces the aerosol provision system 10.

The control circuitry 28 can also be configured to receive additional location information from the external device 40 and update the location information stored in the database in response to receiving the additional location information. For example, having provided the indication of the location of the aerosol provision system 10 to the user, the computing device 40 can be configured to request confirmation from the user that the aerosol provision system 10 was found or otherwise located at the location of the aerosol provision system 10 determined by the control circuitry 28. The user can provide an input via an input device of the external device 40 to indicate whether the submission system 10 was found at the location determined by the control circuitry 28. This indication can then be sent to the control circuitry 28 by the external device 40 as part of the additional location information. Additionally or alternatively, the computing device 40 can be configured to request one or more classifications or descriptions of the location where the aerosol provision system 10 was found or is currently located, for example at home, at work, on a sofa, on a bedside table, or in a work bag or briefcase. For example, as described above the control circuitry 28 may determine that the aerosol provision system 10 is located at the overnight charging location, and the user can apply the classifications of home, bedroom, bedside table to this location using the external device 40. The external device 40 can then send the classification(s) to the control circuitry 28 as part of the additional location information, which the control circuitry 28 uses to update the location information stored in the database. If the control circuitry 28 subsequently determines the location of the aerosol provision system 10 to correspond to the overnight charging location, the control circuitry 28 can then use the location information in the database to determine the one or more classifications or descriptions for the determined location, and the one or more classifications or descriptions can be sent with the indication of the location of the aerosol provision system 10 to the external device 40. This allows the control circuitry 28 to refine its location determination and to provide a more accurate and/or comprehensible description of the determined location of the aerosol provision system 10 to the user.

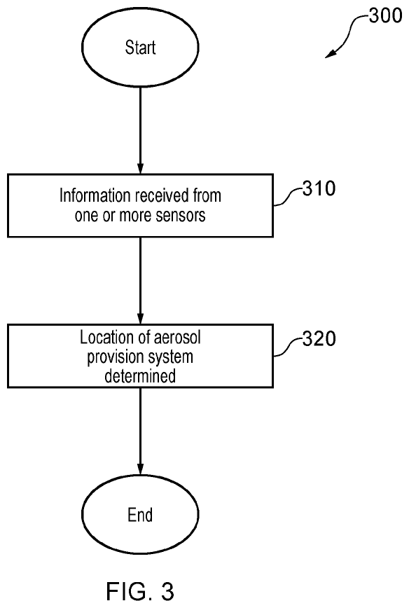

FIG. 3 is a flow diagram of a method 300 for operating an aerosol provision system, such as aerosol provision system 10. The method begins at step 310, where information is received from one or more sensors of the aerosol provision system 10. At step 320, a location of the aerosol provision system 10 is determined based on the received information.

The method illustrated in FIG. 3 may be stored as instructions on a computer readable storage medium, such that when the instructions are executed by a processor, the method described above is performed. The computer readable storage medium may be non-transitory. In other words, the method 300 illustrated in FIG. 3 may be computer implemented. The method 300 may be performed by the aerosol provision device 20, for example by the control circuitry 28.

As described above, the present disclosure relates to (but it not limited to) an aerosol provision system comprising one or more sensors and control circuitry configured to receive information from the one or more sensors, and determine a location of the aerosol provision system based on the received information.

Thus, there has been described aerosol provision device, an aerosol provision system and method.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol provision system comprising:
one or more sensors; and
control circuitry configured to:
receive information from the one or more sensors; and
determine a location of the aerosol provision system based on the received information.

2. The aerosol provision system of claim 1, wherein the one or more sensors comprises an optical sensor configured to measure an amount of light proximate to the aerosol provision system.

3. The aerosol provision system of claim 1, wherein the one or more sensors comprises an accelerometer configured to measure an orientation of the aerosol provision system.

4. The aerosol provision system of claim 1, wherein the one or more sensors comprises a current sensor configured to measure an amount of current received from an external power supply.

5. The aerosol provision system of claim 1, wherein the one or more sensors comprises a temperature sensor configured to measure a temperature of the aerosol provision system.

6. The aerosol provision system of claim 1, wherein the control circuitry is configured to receive the information from the one or more sensors in response to receiving a request from an external device.

7. The aerosol provision system of claim 1, wherein determining the location of the aerosol provision system is further based on location information stored in a database, wherein the location information comprises correlations between information previously received from the one or more sensors and previously determined locations of the aerosol provision system.

8. The aerosol provision system of claim 7, wherein the control circuitry is further configured to update the location information based on the received information and the location of the aerosol provision system.

9. The aerosol provision system of claim 1, wherein the control circuitry is further configured to send an indication of the location of the aerosol provision system to an external device.

10. (canceled)

11. A method for operating an aerosol provision system comprising:
receiving information from one or more sensors of the aerosol provision system; and
determining a location of the aerosol provision system based on the received information.

12. A non-transitory computer readable storage medium comprising instructions which, when executed, perform a method comprising:
receiving information from one or more sensors of the aerosol provision system; and
determining a location of the aerosol provision system based on the received information.

13. The aerosol provision system of claim 7, wherein the control circuitry is configured to receive the information from the one or more sensors in response to receiving a request from an external device.

14. The aerosol provision system of claim 13, wherein the control circuitry is further configured to send an indication of the location of the aerosol provision system to the external device.

15. The aerosol provision system of claim 8, wherein the control circuitry is configured to receive the information from the one or more sensors in response to receiving a request from an external device, and wherein the control circuitry is further configured to send an indication of the location of the aerosol provision system to the external device.

16. The aerosol provision system of claim 8, wherein the control circuitry is configured to update the location information in response to an input from a user confirming that the aerosol provision system was found or otherwise located at the location of the aerosol provision system determined by the control circuitry.

17. The aerosol provision system of claim 8, wherein the control circuitry is configured to update the location information in response to an input from a user with one or more classifications or descriptions of the location where the aerosol provision system was found or otherwise located.

18. The method of claim 11, wherein determining the location of the aerosol provision system is further based on location information stored in a database, wherein the location information comprises correlations between information previously received from the one or more sensors and previously determined locations of the aerosol provision system.

19. The method of claim 18, further comprising updating the location information based on the received information and the location of the aerosol provision system.

20. The non-transitory computer readable storage medium of claim 12, wherein determining the location of the aerosol provision system is further based on location information stored in a database, wherein the location information comprises correlations between information previously received from the one or more sensors and previously determined locations of the aerosol provision system.

21. The non-transitory computer readable storage medium of claim 20, wherein the method performed when executing the instructions further comprises updating the location information based on the received information and the location of the aerosol provision system.
